(19) United States
(12) Patent Application Publication
(10) Pub. No.: US 2002/0191885 A1
(43) Pub. Date: Dec. 19, 2002

(54) Optical component having improved warping symmetry

(76) Inventors: Chi Wu, San Marino, CA (US); Xiantao Yan, Pasadena, CA (US)

Correspondence Address: Travis Dodd, 2490 Heyneman Hollow, Fallbrook, CA, 92028, US

(21) Appl. No.: 09/939,216

(22) Filed: Aug. 24, 2001

Related U.S. Application Data
(63) Continuation-in-part of application No. 09/884,885, filed on Jun. 18, 2001.

(51) Int. Cl. G02B 6/26; G02B 6/10

(52) U.S. Cl. 385/13; 385/129

(57) ABSTRACT

An optical component is disclosed. The optical component includes a base that is more flexible along a first axis than along a second axis. The component also includes one or more waveguides defined in a light transmitting medium. The light transmitting medium is positioned on the base such that the light transmitting medium causes the flexibility of the optical component to be reduced more along the first axis than along the second axis.

### RELATED APPLICATIONS

This application is a continuation-in-part of U.S. patent application Ser. No. 09/884,885; filed on Jun. 18, 2001; entitled “Optical Components With Controlled Temperature Sensitivity” and incorporated herein in its entirety.

### BACKGROUND

1. Field of the Invention

The invention relates to one or more optical networking components. In particular, the invention relates to optical components having a reduced thermal sensitivity.

2. Background of the Invention

Optical networks often employ optical components that include one or more waveguides formed over a substrate. These optical components are often sensitive to temperature changes. For instance, the optical component often warps in response to temperature changes. This warping places stress on the waveguides that can cause the index of refraction of the waveguide to change.

Optical components are generally asymmetrical in that the optical component is more flexible along a first axis than along a second axis. The difference in flexibility causes asymmetrical optical components to warp more along the first axis than along the second axis in response to temperature changes. As a result, the amount of warp induced stress along the first axis is different than the amount of warp induced stress along the second axis. The different stresses can result in a different index of refraction than the first and second axis. This difference in the index of refraction causes different polarity light signals to travel through the light transmitting medium differently. As a result, asymmetrical properties often cause separation of multiple polarity light signals. The separation can reduce the performance of the optical component.

For the above reasons, there is a need for optical components that are not associated with separation of multiple polarity light signals.

### SUMMARY OF THE INVENTION

The invention relates to an optical component. The optical component includes a base that is more flexible along a first axis than along a second axis. The component also includes one or more waveguides defined in a light transmitting medium. The light transmitting medium is positioned on the base such that the light transmitting medium causes the flexibility of the optical component to be reduced more along the first axis than along the second axis.

Another embodiment of the component includes a base being more flexible along a first axis than along a second axis. The component also includes an array waveguide grating having a plurality of array waveguides defined in a light transmitting medium. The light transmitting medium is positioned on the base such that the light transmitting medium causes the flexibility of the optical component to be reduced more along the first axis than along the second axis.

The base can include one or more regions of weakness configured to enhance flexibility of the base along the first axis.

The invention also relates to a method of forming an optical component. The method includes forming a light transmitting medium adjacent to a base. The method also includes forming one or more regions of weakness in a base, the regions of weakness being formed so as to cause the base to be more flexible along a first axis than along a second axis.

The one or more regions of weakness can include one or more grooves formed in the base. The dimensions of the grooves can depend on the dimensions of the optical component. In some instances, the one or more grooves have a depth of at least 2 μm, 4 μm, 8 μm, 10 μm, 30 μm, 50 μm, 100 μm or 200 μm. In some instances, the one or more grooves have a width of at least 4 μm, 8 μm, 10 μm, 20 μm, 50 μm, or 100 μm. In some instance, the one or more grooves are formed in the bottom of the base. In some instances, the one or more regions of weakness include a plurality of parallel grooves.

The one or more regions of weakness can include a plurality of holes formed in the base. The dimensions of the holes can depend on the dimensions of the optical component. In some instances, the one or more holes have a depth of at least 2 μm, 4 μm, 10 μm, 50 μm, or 100 μm. In some instances, the one or more holes have a diameter of at least 4 μm, 10 μm, 20 μm, 50 μm, or 100 μm. In some instances, the holes are formed in the bottom of the base.

The base can be constructed from a single material or from a plurality of layers. In some instances, the base includes a warping layer configured to cause warping of the component in response to temperature changes. In some instances, the warping layer is constructed of a single layer of metal, a bi-metal, a polymer or epoxy materials.

In some instances, the one or more waveguides are at least partially defined by a ridge formed in the light transmitting medium. In one embodiment, the ridge is positioned over a pocket formed in the base.

### BRIEF DESCRIPTION OF THE FIGURES

FIG. 1A is a perspective view of a portion of an optical component having a light transmitting medium positioned on a base. The illustrated portion of the optical component includes a waveguide.

FIG. 1B is a topview of the portion of the optical component illustrated in FIG. 1A.

FIG. 1C is a cross section of the optical component of FIG. 1B taken at the line labeled A.

FIG. 1D illustrates an optical component where the optical component includes a cladding layer.

FIG. 2A is a topview of an optical component having a light transmitting medium positioned on a base. The light transmitting medium is positioned on the base such that the light transmitting medium reduces the flexibility of the optical component more along a first axis than along a second axis.

FIG. 2B is a bottomview of the optical component shown in FIG. 2A. The base includes regions of weakness causing the base to be more flexible along the first axis than along the second axis.

FIG. 2C is a sideview of the optical component shown in FIG. 2A.

FIG. 3A is a bottomview of an optical component. The base includes regions of weakness that each includes a plurality of holes formed in the base.

FIG. 3B is a cross sectional view of the optical component shown in FIG. 3A taken at the line labeled A in FIG. 3A.

FIG. 4 is a bottomview of an optical component. The base is constructed from a plurality of spaced apart sections. The gap between adjacent sections serves as a region of weakness that increases the flexibility of an optical component along an axis.

FIG. 5A through FIG. 5D illustrate a variety of suitable base constructions.

FIG. 6 illustrates an embodiment of an optical component having a gap between the light transmitting medium associated with different waveguides.

FIG. 7A through FIG. 7E illustrate a method for forming an optical component having one or more waveguides

### DETAILED DESCRIPTION OF THE PREFERRED EMBODIMENT

The invention relates to optical components. The optical components include a light transmitting medium positioned over a base. One or more waveguides are defined in the light transmitting medium.

The light transmitting medium is positioned on the base such that the light transmitting medium provides more resistance to bending of the optical component along a first axis than along a second axis. The base is constructed so as to be more flexible along the first axis than along the second axis. The enhanced flexibility of the base along the first axis balances the effects of the light transmitting medium on the flexibility of the optical component. As a result, the enhanced flexibility of the base brings the flexibility of the optical component along the first axis closer to the flexibility of the optical component along the second axis. In some instances, the flexibility of the optical component along the first axis is within the lei flexibility along the second axis +/−10%, +/−5%, +/−3%, +/−2%, +/−1% or +/−0.5% of the flexibility of the optical component along the second axis. When the flexibility of the optical component along the first axis approaches the flexibility of the optical component along the second axis, the amount of warp induced stress along the first axis approaches the amount of warp induced stress along the second axis and the separation of the different polarity light signals is reduced.

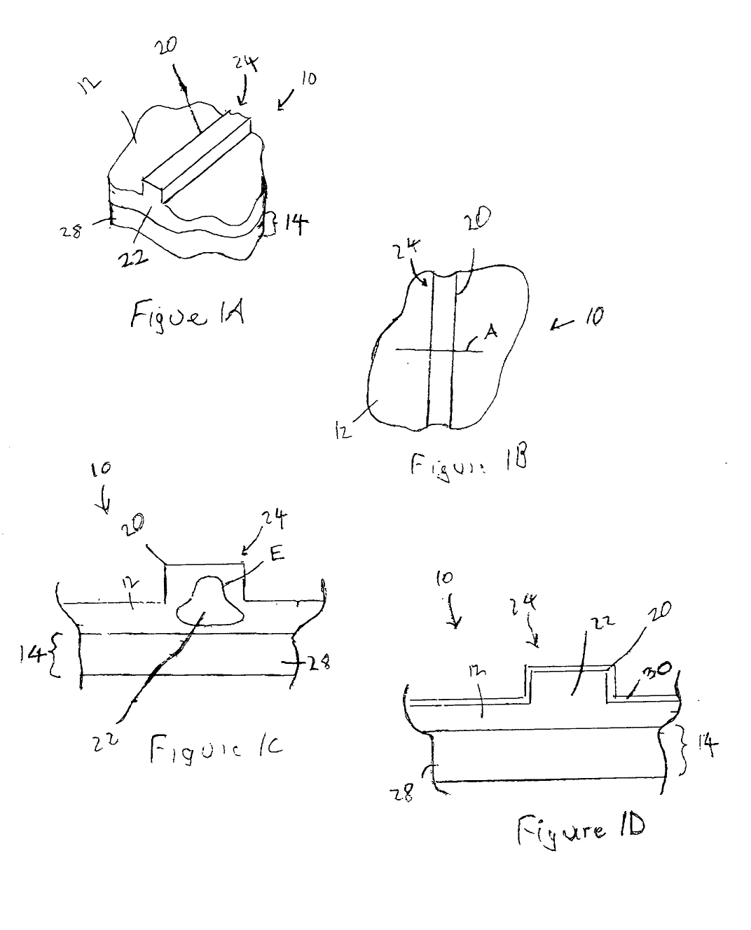

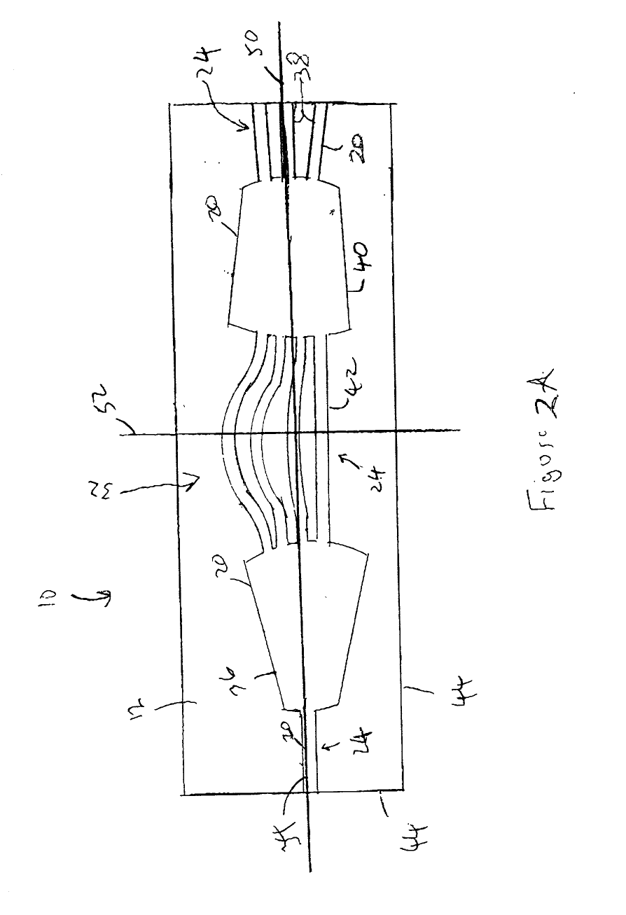

FIG. 1A through FIG. 1C illustrate a suitable construction of an optical component 10. FIG. 1A is a perspective view of a portion of the optical component 10. FIG. 1B is a topview of a portion of an optical component constructed according to FIG. 1A. FIG. 1C is a cross section of the optical component shown in FIG. 1B taken at the line labeled A.

The optical component 10 includes a light transmitting medium 12 positioned over a base 14. The light transmitting medium 12 includes a ridge 20 that defines a portion of the light signal carrying region 22 of a waveguide 24. Suitable light transmitting media include, but are not limited to, silicon, polymers and silica.

The portion of the base 14 located under the ridge 20 includes a material that reflects light signals from the light signal carrying region 22 back into the light signal carrying region 22. As a result, base 14 also defines a portion of the light signal carrying region 22. The line labeled E illustrates the profile of a light signal carried in the light signal carrying region 22 of FIG. 1C.

A cladding 30 can optionally be positioned over the light transmitting medium 12 as shown in FIG. 1D. The cladding 30 can have an index of refraction less than the index of refraction of the light transmitting medium 12 so light signals from the light transmitting medium 12 are reflected back into the light transmitting medium 12.

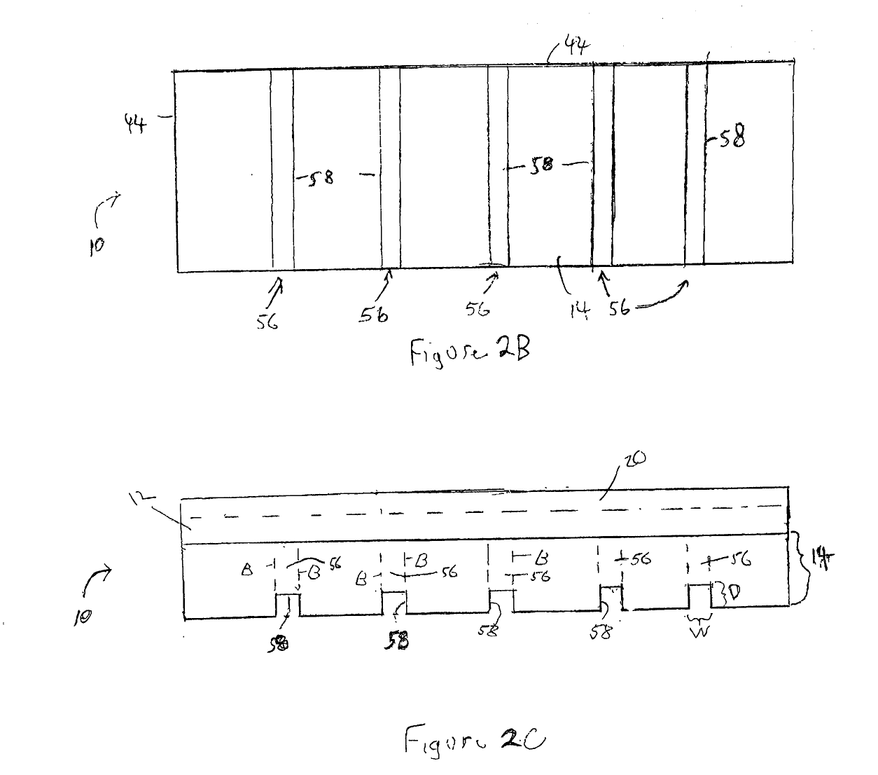

FIG. 2A through FIG. 2C provide an example of an optical component constructed according to FIG. 1A through FIG. 1C. FIG. 2A is a topview of an optical component having a demultiplexer. The demultiplexer includes an input waveguide 34 in optical communication with an input star coupler 36 and a plurality of output waveguides 38 in optical communication with an output star coupler 40.

A plurality of array waveguides 42 provide optical communication between the input star coupler 36 and the output star coupler 40. The length of each array waveguide 42 is different and the length differential between adjacent array waveguides 42, ΔL, is a constant.

During operation of the optical component, light signals from the input waveguide 34 enter the input star coupler 36. The input star coupler distributes the light signal to a plurality of the array waveguides 42. The light signals travel through the array waveguides 42 into the output star coupler 40. Because the adjacent array waveguides 42 have different lengths, the light signal from each array waveguide 42 enters the output star coupler 40 in a different phase. The phase differential causes the light signal to be focused at a particular one of the output waveguides 38. The output waveguide 38 on which the light signal is focused is a function of the wavelength of light of the light signal. Accordingly, light signals of different wavelengths are focused on different output waveguides 38. As a result, each output waveguide 38 carries a light signal of a different wavelength.

The illustrated optical component 10 is not proportional and the number of waveguides 24 is not necessarily representative. For instance, four array waveguides 42 are shown but demultiplexers 32 often include a different number of array waveguides 42 and can include as many as several tens or hundreds of array waveguides 42. Further, the demultiplexer 32 can include more than three output waveguides 38 although three output waveguides 38 are shown.

The base 14 and the light transmitting medium 12 often have different coefficients of thermal expansion. As a result, the component often warps in response to temperature changes. Many optical components are asymmetrical in that they warp more along a first axis than along a second axis. The asymmetry results from the component being more flexible along the first axis than along the second axis. The flexibility of the component can be variable along an axis. As a result, the flexibility along an axis can refer to the flexibility per unit length averaged over the length of the component on the axis. Additionally, flexibility is a measure of stiffness. Accordingly, various measures of stiffness can be employed to quantify flexibility.

The first axis and the second axis can define a plane that is parallel to at least a portion of the longitudinal axis of two or more waveguides 24 on the optical component. The longitudinal axis of a waveguide 24 is parallel to the direction of propagation of light signals through the waveguide 24. When the component includes a single waveguide 24 or is configured such that the a plane can not be defined parallel to a longitudinal axis of two or more waveguides 24, the plane defined by the first axis and the second axis can be parallel to a plane defined by the interface between the base 14 and the waveguides 24 positioned on the base 14 or to a plane defined by a bottom of the base 14.

When the optical component has one or more straight lateral sides, the first axis and/or the second axis can be parallel to a lateral side of the optical component. In some instances, the first axis and the second axis can be perpendicular to one another or arranged at another angle.

FIG. 2A provides an example of an asymmetrical optical component. A first axis 50 and a second axis 52 are shown overlaid on the optical component 10. The first axis 50 and the second axis 52 define a plane parallel to the longitudinal axis of each waveguide 24. The first axis 50 and the second axis 52 are perpendicular to one another and are each parallel to a lateral side 44 of the optical component. When the component warps, the ridge 20 that defines the waveguides 24, the input star coupler 36 and the output star coupler 40 provides asymmetrical resistance to bending of the optical component 10. For instance, the ridges 20 effectively act as I-beams that resist bending of the optical component 10 along the longitudinal axis of the waveguide 24 but does not provide large resistance to bending of the optical component 10 along an axis perpendicular to the longitudinal axis of the waveguide 24. Because the longitudinal axis of the waveguides 24 illustrated in FIG. 2A is more aligned with the first axis 50 than the second axis 52, the light transmitting medium 12 is arranged on the base 14 such that light transmitting medium 12 resists bending of the optical component along the first axis 50 more than along the second axis 52.

As shown in FIG. 2B through FIG. 2C, the base 14 can include one or more regions of weakness 56 at which the flexibility of the base 14 is enhanced. FIG. 2B is a bottomview of a base 14 for use with the optical component 10 of FIG. 2A. FIG. 2C is a sideview an optical component including the base 14 of FIG. 2B bonded to the optical component 10 of FIG. 2A. The dashed line labeled A in FIG. 2C illustrates the location of the base 14 of the ridge 20 on the optical component 10. The dashed lines labeled B illustrate the perimeter of a region of weakness where the base has enhanced flexibility.

The regions of weakness 56 are arranged so as to bring the flexibility of the optical component along the first axis 50 closer to the flexibility along the second axis 52 than is achieved without the regions of weakness 56. The regions of weakness 56 can be configured such that the flexibility of the optical component along the first axis is within the flexibility along the second axis +/−10%, +/−5%, +/−3%,+/−2% or +/−1%.

The regions of weakness 56 include one or more grooves 58. For instance, the regions of weakness 56 illustrated in FIG. 2B and FIG. 2C include a plurality of grooves 58 that extend across the optical component. The grooves 58 are parallel to a lateral side 44 of the optical component and extend across the first axis 50 when looking at a topview of the optical component. In some instances, the one or more grooves have a depth, D, of at least 2 μm, 4 μm, 8 μm, 10 μm, 30 μm, 50 μm, 100 μm or 200 μm. In some instances, the one or more grooves have a width, W, of at least 4 μm, 8 μm, 10 μm, 20 μm, 50 μm, or 100 μm. Although the grooves 58 are shown as extending part way into the base 14, the grooves 58 can be formed through the base 14 to the light transmitting medium 12.

The grooves 58 increase the flexibility of the base 14 along the first axis 50 more than along the second axis 52. When the light transmitting medium 12 is formed on the base 14, the enhanced flexibility of the base 14 along the first axis 50 balances the loss in flexibility along the first axis 50 caused by the presence of the waveguides 24. As a result, the regions of weakness 56 in the base 14 bring the flexibility of the optical component along the first axis 50 closer to the flexibility of the optical component along the second axis 52. When the flexibility of the optical component along the first approaches the flexibility of the optical component along the second axis, the amount of warp induced stress along the first axis approaches the amount of warp induced stress along the second axis and the separation of the different polarity light signals is reduced.

The one or more grooves 58 can extend across the optical component as shown in FIG. 2B. Alternatively, the one or more grooves 58 can extend part way across the optical component. A groove 58 provides a larger increase in flexibility when it extends all the way across the optical component than when it extends part way across the optical component.

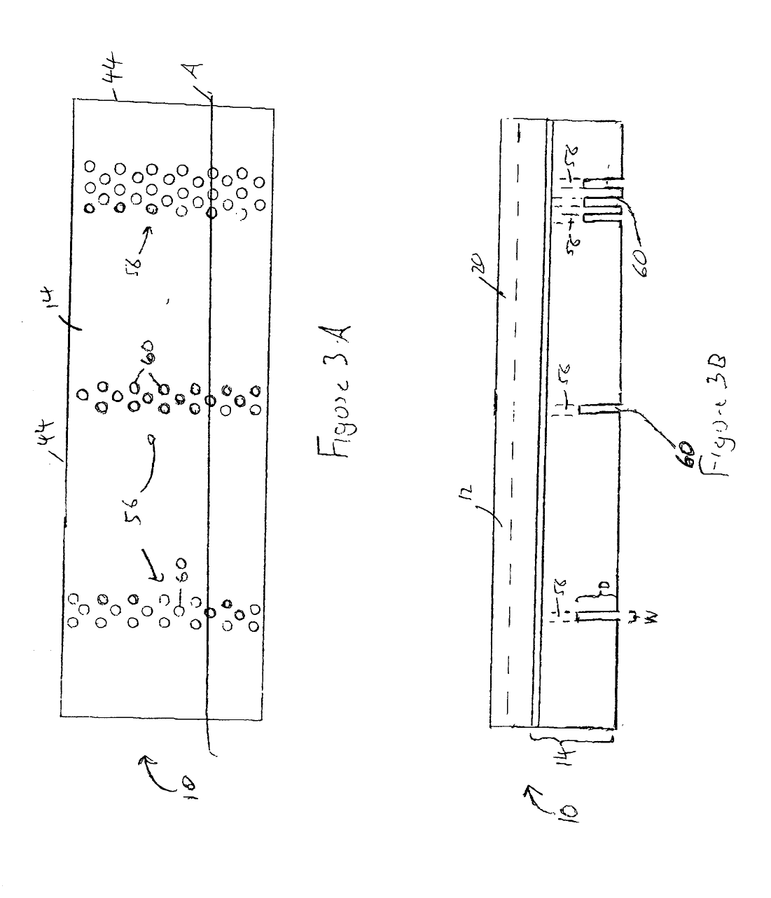

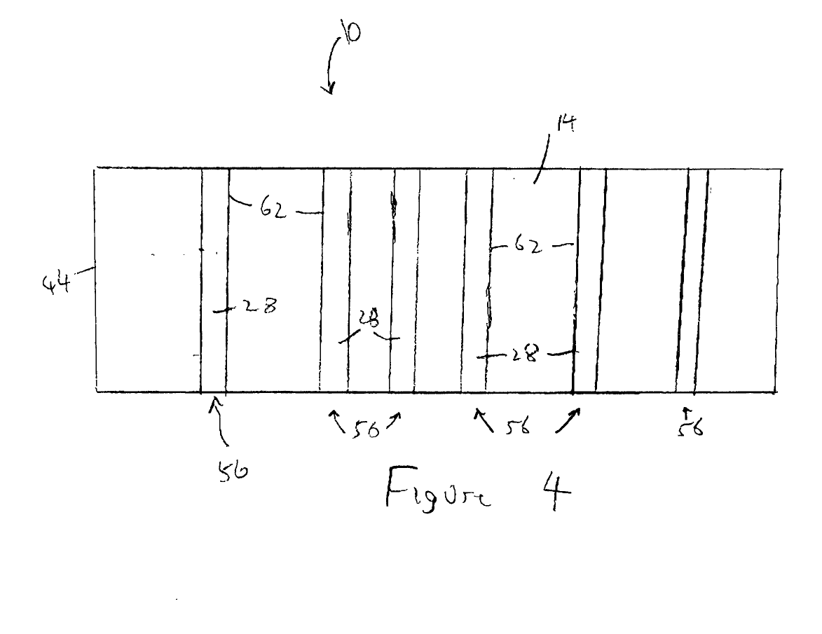

The one or more regions of weakness 56 need not include grooves 58. For instance, the one or more regions of weakness 56 can include holes 60 as shown in FIG. 3A and FIG. 3B. FIG. 3A is a bottom view of a base 14 and FIG. 3B is a cross section of the base 14 taken at the line labeled A. The holes 60 are grouped so as to form the regions of weakness 56. In some instances, the one or more holes have a depth, D, of at least 2 μm, 4 μm, 10 μm, 50 μm, or 100 μm. In some instances, the one or more holes have a diameter, W, of at least 4 μm, 10 μm, 20 μm, 50 μm, or 100 μm. In some instances, the holes are formed in the bottom of the base. Although the holes 60 are shown as extending part way into the base 14, the holes 60 can be formed through the base 14 to the light transmitting medium 12.

The regions of weakness 56 can also be gaps 62 between sections of the base 14 as shown in FIG. 4. FIG. 4 is a bottomview of the optical component. The regions of weakness 56 can include grooves 58 that extend across and through the base 14. In some instances, the base 14 can be constructed from a plurality of spaced apart sections. The gap 62 between the sections can serve as the region of weakness 56 in the base 14.

The regions of weakness 56 preferably extend across the least flexible axis of the optical component 10 when viewed from a topview of the optical component. The least flexible axis is often not parallel to the lateral sides 44 of the optical component 10. As a result, the one or more regions of weakness 56 need not be positioned parallel to a lateral side 44 of the optical component 10. Further, the regions of weakness 56 need not extend across the least flexible axis of the optical component 10 in order to provide effective equalization of the stress along the first and second axis 52.

The regions of weakness 56 need not be evenly spaced. For instance, the density of the regions of weakness 56 can be higher under the star couplers of FIG. 2A than under the waveguides 24 in order to create a more uniform flexibility along the first axis 50. Additionally, each region of weakness 56 need not have the same dimensions. For instance, when the regions of weakness 56 include grooves 58, the grooves 58 under the star couplers of FIG. 2A can be wider than the grooves 58 under the waveguides 24 in order to provide a more uniform flexibility of the optical component along the first axis 50.

Although the regions of weakness 56 are shown as being parallel to one another, the regions of weakness 56 need not be parallel. For instance, the regions of weakness 56 can be angled relative to one another or can cross one another. Further, the regions of weakness 56 need not be parallel to the lateral sides 44 of the optical component 10 as shown above.

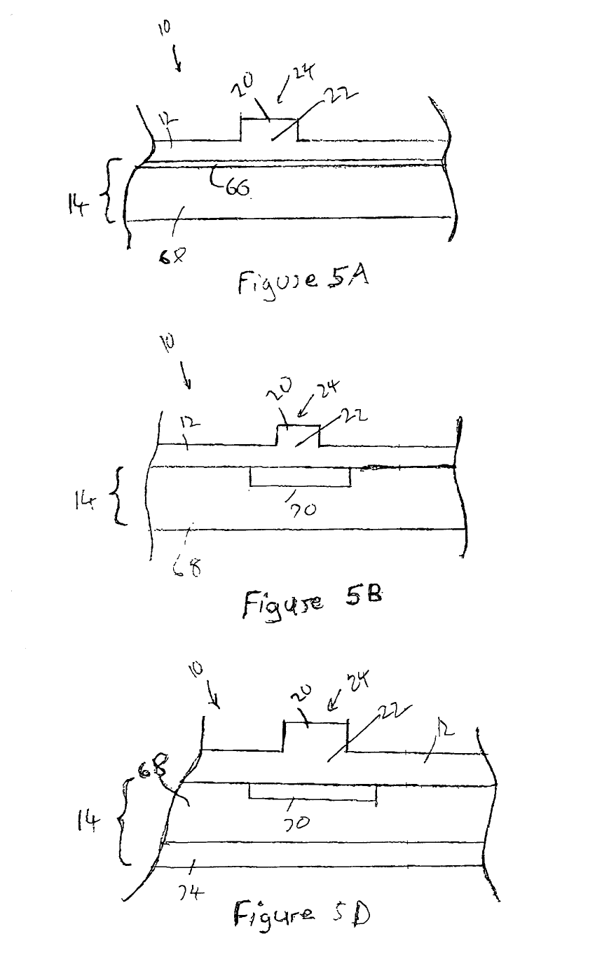

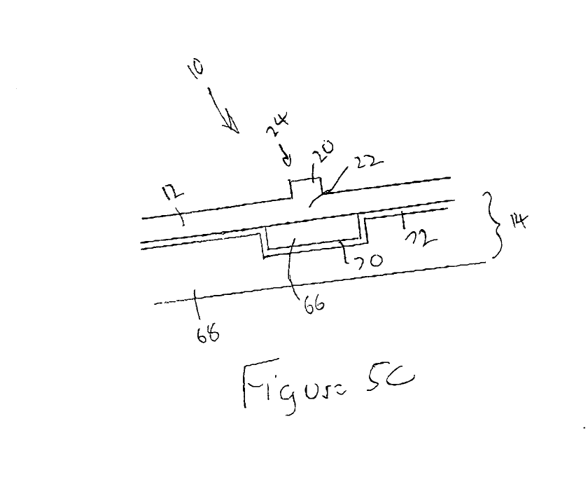

The base 14 can have as variety of constructions. FIG. 5A through FIG. 5D illustrate cross sections of optical components having a variety of different base 14 constructions. FIG. 5A illustrates a base 14 having a light barrier 66 positioned over a substrate 68. The light barrier 66 is constructed of a material that causes light signals from the light signal carrying region 22 to be reflected back into the light signal carrying region 22. This reflection can result from the light barrier 66 having an index of refraction that is less than the index of refraction of the light transmitting medium 12. When the light transmitting medium 12 is silicon, a suitable light barrier 66 can be constructed from silica and a suitable substrate 68 can be constructed from silicon. An optical component having this material selection can be constructed from a silicon on insulator wafer 86.

FIG. 5B illustrates a base 14 having a pocket 70 formed in a substrate 68. The ridge 20 is positioned over the pocket 70. The pocket 70 contains a medium that causes light signals from the light signal carrying region 22 to be reflected back into the light signal carrying region 22. A suitable material for including in the pocket 70 includes air. A suitable material for the substrate 68 includes, but is not limited to, silicon.

Constructing an optical component with pockets 70 formed in the base 14 can enhance the asymmetrical warping nature of the optical component. Because the optical component extends alongside the waveguides 24, the pocket 70 can increase the flexibility of the optical component along an axis perpendicular to the longitudinal axis of a waveguide 24. For instance, when the base 14 on the optical component illustrated in FIG. 2A is constructed with each ridge 20 located over a pocket 70, the pocket 70 can further increase the flexibility of the component along the second axis 52. As a result, this construction can enhance the role played by the regions of weakness 56.

The bases 14 can be constructed from one or more other layers of material. For instance, a layer of material 72 can be formed over the substrate 68 as illustrated in FIG. 5C. A suitable layer of material 72 includes, but is not limited to silica. Further, the base 14 can include a warping member 74 as illustrated in FIG. 5D. The warping member 74 can be configured to cause warping of the optical component so as to increase or decrease the temperature sensitivity of the optical component. Examples of warping members 74 include a single layer of metal, epoxy or polymer. Alternatively, the warping member 74 can be a bimetal. Suitable warping members 74 are described in U.S. patent application Ser. No. 09/884,885; filed on Jun. 18, 2001 and entitled “Optical Component With Controlled Temperature Sensitivity.”

When the base 14 includes one or more layers of material, the regions of weakness 56 can be formed in the bottom of the optical component. Further, the one or more regions of weakness 56 can be formed between layers. For instance, when the optical component includes a warping member 74, the regions of weakness 56 in the bottom of the substrate 68 or in the top of the warping member 74. As a result, the regions of the substrate 68 are located between the substrate 68 and the warping member 74. A region of weakness 56 provides a larger increase in flexibility when it is positioned in the bottom of the optical component than when a region of weakness 56 with the same dimensions is located between layers.

Although the above illustrations of an optical component show the light transmitting medium 12 extending between adjacent waveguides 24, the light transmitting medium 12 can be more localized to the waveguides. For instance, FIG. 6 illustrates a cross section of an optical component having gaps 76 between the light transmitting medium 12 associated with different waveguides 24. Although the light transmitting medium 12 is not continuous across the base 14, the light transmitting medium 12 can provide more resistance to bending of the optical component along a first axis 50 than along a second axis 52. The width of the light transmitting medium 12 associated with each waveguide can be about the same. As a result, the gaps 76 between adjacent waveguides 24 can have different widths. Additionally, when two waveguides 24 intersect or cross one another the gap 76 between the waveguides 24 will converge to the point of crossing or intersection.

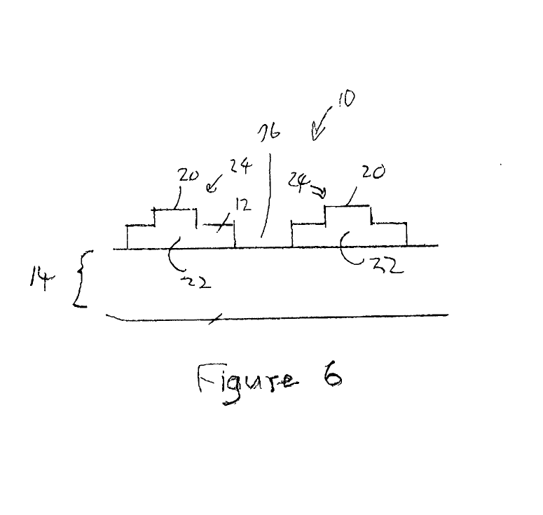

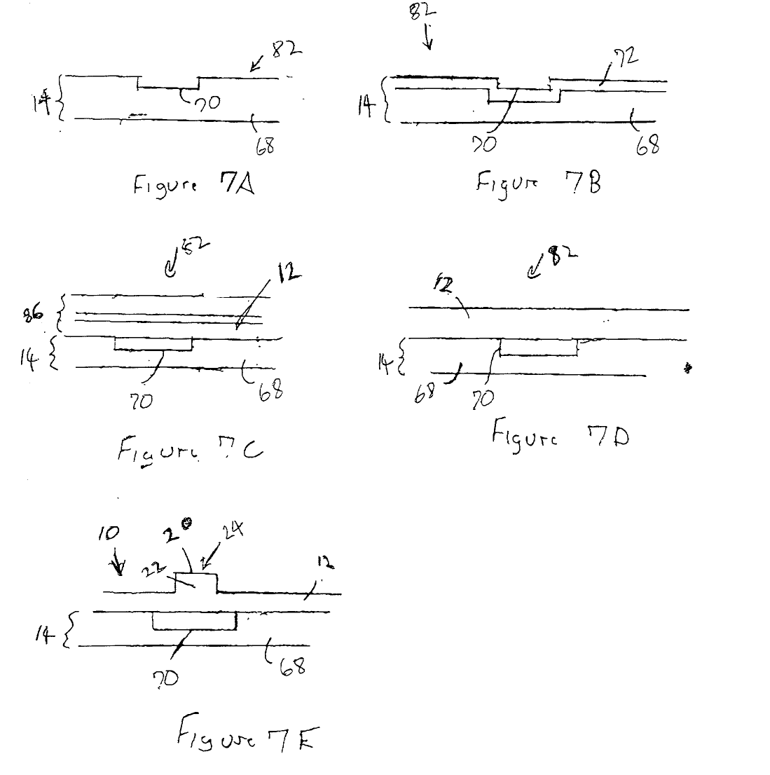

FIG. 7A to FIG. 7E illustrate a method for forming an optical component having one or more waveguides 24. A mask is formed on a base so the portions of the base 14 where pockets are to be formed remain exposed. A suitable base 14 includes, but is not limited to, a silicon substrate 68. An etch is performed on the masked base 14 to form pockets 70.

Air can be left in the pockets 70 to serve as the light barrier 66. Alternatively, a light barrier 66 material such as silica or a low K material can be grown or deposited in the pockets 70. The mask is removed to provide the optical component precursor 82 illustrated in FIG. 7A.

A layer of material 72 can optionally be deposited or grown over the base 14 as illustrated in FIG. 7B.

The remainder of the method is disclosed presuming that the layer of material 72 is not deposited or grown in the pocket 70 and that air will remain in the pocket 70 to serve as the light barrier 66. A light transmitting medium 12 is formed over the base 14. A suitable technique for forming the light transmitting medium 12 over the base 14 includes, but is not limited to, employing wafer bonding techniques to bond the light transmitting medium 12 to the base 14. A suitable wafer for bonding to the base 14 includes, but is not limited to, a silicon wafer or a silicon on insulator wafer 86.

A silicon on insulator wafer 86 includes a silica layer positioned between silicon layers as shown in FIG. 7C. The top silicon layer and the silica layer can be removed to provide the optical component precursor 82 shown in FIG. 7D. Suitable methods for removing the top silicon layer and the silica layer include, but are not limited to, etching and polishing. The bottom silicon layer remains as the light transmitting medium 12 where the waveguides 24 will be formed. When a silicon wafer is bonded to the base 14, the silicon wafer will serve as the light transmitting medium 12. A portion of the silicon layer can be removed from the top and moving toward the base 14 in order to obtain a light transmitting medium 12 with the desired thickness.

A silicon on insulator wafer 86 can be substituted for the optical component precursor 82 illustrated in FIG. 7D. The silicon on insulator wafer 86 preferably has a top silicon layer with a thickness that matches the desired thickness of the light transmitting medium 12. The remainder of the method is performed using the silicon on insulator wafer 86 substituted for the optical component precursor 82 of FIG. 7D.

The light transmitting medium 12 is masked such that places where a ridge 20 is to be formed are protected. In some instances, the mask is formed so as to protect regions where the mode reducing regions, the multimode regions and the transition regions are to be formed. The optical component precursor 82 is etched to a depth that provides an optical component with ridges 20 of the desired height as shown in FIG. 7E. When the height and thickness of the waveguide 24 is the same along the entire length of a waveguide 24, the etch can form the entire waveguide 24. As a result, there is no need to employing multiple etches when forming the waveguide 24.

When the optical component will include a cladding 30, the cladding 30 can be formed at different places in the method. For instance, the cladding 30 can be deposited or grown on the optical component of FIG. 7E. Alternatively, the cladding 30 can be created by converting a portion of the light transmitting medium 12 to the cladding 30. For instance, when the light transmitting medium 12 is silicon, the optical component can be annealed to convert the exposed silicon to silica.

When the optical component will include gaps 76 between the light transmitting medium 12 associated with different waveguides 24, the gaps 76 can be formed between adjacent waveguides 24 by performing a mask and etch on the optical component illustrated in FIG. 7E.

The one or more regions of weakness 56 can be formed before or after the light transmitting medium 12 is formed on the base 14. Suitable methods of forming the regions of weakness 56 include, but are not limited to, milling, drilling, etching and cutting including laser cutting and drilling. When the regions of weakness 56 are formed after the base 14 is attached to the optical component 10, the region of weakness 56 can extend through the base 14to the light transmitting medium. When the regions of weakness 56 are formed by the gaps 62 between sections of the base 14, attaching the sections of the base 14 to the optical component 10 such that the sections of base 14 are spaced apart from one another can form the gaps 62.

Although the regions of weakness 56 are shown above as gas filled recesses, the regions of weakness 56 can be filled with other materials. For instance, the regions of weakness 56 can be filled with an elastic material such as a rubber. The elastic material can provide a smooth surface to the optical component while still increasing the flexibility of the optical component.

The dimensions and layout of the one or more regions of weakness 56 can be experimentally fine tuned. These parameters can be determined by delivering a multipolarity light signal into a waveguide 24 on the optical component 10 and measuring the separation between the different polarities. The dimensions of the regions of weakness 56 can be changed to find where the separation approaches zero. For instance, when one or more regions of weakness 56 include a groove 58, the depth and width of the grooves 58 can be increased to find where the lowest separation in the polarities occurs. If the level of separation that can be achieved is not satisfactory another layout of the one or more regions of weakness 56 can be tried. For instance, the number of regions of weakness 56 can be changed or the regions of weakness 56 can be formed with a different orientation relative to the waveguides 24 on the optical component 10. Once the desired dimensions for the regions of weakness 56 are determined, the regions of weakness 56 can be formed in the base 14 before the light transmitting medium 12 is formed on the base 14.

The etch(es) employed in the method described above can result in formation of a facet and/or in formation of the sides of a ridge 20 of a waveguide 24. These surfaces are preferably smooth in order to reduce optical losses. Suitable etches for forming these surfaces include, but are not limited to, reactive ion etches, the Bosch process and the methods taught in U.S. patent application Ser. No. 09/690,959; filed on Oct. 16, 2000; and entitled “Formation of a Smooth Vertical Surface on an Optical Component” and U.S. patent application Ser. No. 09/845,093; filed on Apr. 27, 2001 and entitled “Formation of an Optical Component Having Smooth Sidewalls” which are each incorporated herein in their entirety.

Although the optical component is disclosed in the context of optical components having ridge waveguides, the principles of the present invention can be applied to optical components having other waveguide types. Suitable waveguide types include, but are not limited to, buried channel waveguides and strip waveguide.

Although the optical component is disclosed in the context of an optical component having a demultiplexer, the optical component is not limited to optical systems that include demultiplexers. For instance, the optical component can include optical components with amplifiers, dispersion compensators, filters, switches and other components.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

What is claimed is:

1. An optical component, comprising:
a base being more flexible along a first axis than along a second axis; and
one or more waveguides defined in a light transmitting medium, the light transmitting medium being positioned on the base so as to reduce the flexibility of the optical component more along the first axis than along the second axis.

2. The component of claim 1, wherein the flexibility of the optical component along the first axis is within the flexibility of the optical component along the second axis +/−5%.

3. The component of claim 1, wherein the flexibility of the first axis is within the flexibility of the optical component along the second axis +/−1%.

4. The component of claim 1, wherein the base includes one or more regions of weakness configured to enhance flexibility of the base along the first axis.

5. The component of claim 4, wherein the one or more regions of weakness include one or more grooves formed in the base.

6. The component of claim 5, wherein the one or more grooves have a depth of at least 10 μm.

7. The component of claim 5, wherein the one or more grooves have a width of at least 4 μm.

8. The component of claim 4, wherein the one or more regions of weakness include a plurality of parallel grooves formed in the base.

9. The component of claim 4, wherein the one or more regions of weakness are positioned in a bottom of the base, the bottom of the base being opposite the light transmitting medium.

10. The component of claim 4, wherein the one or more regions of weakness include a plurality of holes formed in the base.

11. The component of claim 10, wherein the holes have a depth of at least 10 μm.

12. The component of claim 10, wherein the holes have a width of at least 20 μm.

13. The component of claim 4, wherein the one or more regions of weakness extend across the first axis when looking at a topview of the optical component.

14. The component of claim 4, wherein the one or more regions of weakness are parallel to a lateral side of the component.

15. The component of claim 1, wherein the base is constructed from a single material.

16. The component of claim 1, wherein the base includes a layer of metal.

17. The component of claim 1, wherein the base includes a bi-metal.

18. The component of claim 1, wherein the base includes a layer of material selected from a group consisting of polymer and epoxy.

19. The component of claim 1, wherein the one or more waveguides are at least partially defined by a ridge formed in the light transmitting medium.

20. The component of claim 19, wherein the ridge is positioned over a pocket formed in the base.

21. The component of claim 1, wherein the first axis and the second axis define a plane parallel to a plane defined by at least a portion of the longitudinal axis of two or more of the waveguides.

22. The component of claim 1, wherein the first axis and the second axis define a plane parallel to a plane defined by a bottom side of the light transmitting medium, the bottom side of the light transmitting medium being positioned adjacent to the base.

23. An optical component, comprising:
a base being more flexible along a first axis than along a second axis; and
an array waveguide grating having a plurality of array waveguides defined in a light transmitting medium, the light transmitting medium being positioned on the base so as to reduce the flexibility of the optical component more along the first axis than along the second axis.

24. The component of claim 23, wherein the flexibility of the optical component along the first axis is within the flexibility of the optical component along the second axis +/−5%.

25. The component of claim 23, wherein the flexibility of the first axis is within the flexibility of the optical component along the second axis +/−1%.

26. The component of claim 23, wherein the base includes one or more regions of weakness configured to enhance flexibility of the base along the first axis.

27. The component of claim 26, wherein the one or more regions of weakness include one or more grooves formed in the base.

28. The component of claim 26, wherein the one or more regions of weakness include a plurality of holes formed in the base.

29. The component of claim 23, wherein the base includes a layer of metal.

30. The component of claim 23, wherein the base includes a layer of material selected from a group consisting of polymer and epoxy.

31. The component of claim 23, wherein the one or more waveguides are at least partially defined by a ridge formed in the light transmitting medium.

32. A method of forming an optical component, the method including:
forming a light transmitting medium adjacent to a base; and
forming one or more regions of weakness in a base, the regions of weakness being formed so as to cause the base to be more flexible along a first axis than along a second axis.

33. The method of claim 32, wherein the regions of weakness are formed in the base before the light transmitting medium is formed adjacent to the base.

34. The method of claim 32, wherein the regions of weakness are formed in the base after the light transmitting medium is formed adjacent to the base.

35. The method of claim 32, further comprising:
defining one or more waveguides in the light transmitting medium, the waveguides being defined such that the light transmitting medium causes the flexibility of the optical component along the first axis to be reduced more than the flexibility of the optical component along the second axis.
